(19) United States
(12) Patent Application Publication
(10) Pub. No.: US 2008/0013009 A1
(43) Pub. Date: Jan. 17, 2008

(54) Color Liquid Crystal Display Device

(75) Inventor: Toshiya Inada, Hyogo (JP)

Correspondence Address: LIU & LIU, 444 S. FLOWER STREET, SUITE 1750, LOS ANGELES, CA, 90071, US

(73) Assignee: TPO Hong Kong Holding Limited

(21) Appl. No.: 11/791,007

(22) PCT Filed: Dec. 26, 2005
(86) PCT No.: PCT/IB05/54400

§ 371 Date: May 16, 2007

(30) Foreign Application Priority Data
Dec. 28, 2004 (JP) 2004-381701

(51) Int. Cl. G02F 1/136

(52) U.S. Cl. 349/46

(57) ABSTRACT

In a color liquid crystal display device, pixel electrodes are partially overlap with source electrodes and polarity inversions are carried out to any adjacent pair of unit columns of the pixels or any adjacent pair of unit pixels along the row direction, to eliminate adversely effect of crosstalk. A color liquid crystal display device wherein liquid crystal material is sandwiched between a TFT substrate with control circuits of thin film transistors (TFrs) and a substrate located opposed to it, a plurality of rows and columns of picture elements are arranged in matrix, each row having a gate bus and each column having a source bus, polarity inversions are carried out to any adjacent pair of unit columns of the pixels or any adjacent pair of unit pixels along the row direction, and pixel electrodes partially overlap with or are close to the source buses at their respective lateral ends, is characterized in that the electrodes are arranged so that a parasitic capacitances between pixel electrodes and the source buses are identical at their respective lateral ends, and that two or more types of color layers are allocated to picture cells connected to the same source bus with the same allocation rate.

### TECHNICAL FIELD

The present invention relates to a color liquid crystal display device, and particularly to an improved structure which is capable of enhanced display quality.

### BACKGROUND ART

Color liquid crystal devices have been commonly used with a wide variety of electronic devices and appliances.

In such color liquid crystal display devices, liquid crystal material is sandwiched between a TFT substrate with control circuits of thin film transistors (TFTs) and a substrate located opposed to it, and a plurality of rows and columns of picture elements (pixels) are arranged in matrix form, each row having a gate bus and each column having a source bus. Also, current color filters for such devices typically employ those of a longitudinal stripe layout where color filters of three colors of Red, Green and Blue in a certain pattern are generally disposed in sequence for each column.

Additionally, these recent color liquid crystal devices have pixel electrodes formed in a layer different from layer containing bus lines of source and gate buses, and in the lamination layout the pixel electrodes are laid directly over the bus lines, so that the bus lines themselves serve as a light-shielding zone from back light so as to raise an aperture ratio.

FIGS. 4A and 4B show examples of a vertical cross-section of the liquid crystal display device, and a TFT substrate and a glass substrate in the opposed substrate are omitted for convenience of understanding. A liquid crystal layer 1 is superposed with an overlayer of drain electrodes 2, and if the layer is light transmission-type, an ITO layer is used for it, but if not, a reflective layer is used. Source electrodes 3, 4 underlie the liquid crystal layer 1. Relationships between the drain electrodes 2 and the source electrodes 3, 4 are depicted in FIG. 4A where the drain electrodes 2 and the source electrodes 3, 4 are overlapped at their respective partial horizontal positions, and there also arises a case as in FIG. 4B where they do not overlap at their respective partial horizontal positions but exist in the same vicinity. When they are overlapped, a degree of the overlap varies from one liquid crystal display device to another, but the overlapping with the pixel electrode layer is fixed in any device. When there is no overlapping between the drain and source layers, any appropriate light shielding means such as a black matrix is required to prevent back light beams from leaking through gaps between the pixel electrode layer and the source and bus layers.

In the structure, as stated above, a parasitic capacitance will be developed between the sources and the drains due to the overlapping and parts where source, drain and pixel layers are disposed in the same vicinity. The parasitic capacitance is defined as CSDL or CSDR depending on its position on left and right sides of a single opposite electrode as in FIG. 3. The parasitic capacitance typically occurs if there is the overlap and/or close juxtaposition of the layers as previously mentioned.

[PRIOR PATENT DOCUMENT 1]

US Patent Laid-open Publication No. 20020024491A1

### DISCLOSURE OF INVENTION

### Technical Problem

The parasitic capacitance derived from the overlapping of the drain electrodes and the source electrodes may disadvantageously cause deteriorations in display quality such as crosstalk, which is well known in the art.

Described below will be a mechanism on the causes from which the crosstalk occurs due to the parasitic capacitance between the source electrodes and the drain electrodes.

FIG. 5 is a circuit diagram showing a model of a single pixel cell where a liquid crystal cell Clc is connected to a transistor T having its gate connected to a gate line G, which resultantly connects the liquid crystal cell Clc to a source bus S. Turning on the transistor causes data or voltage at the source bus to be applied to the liquid crystal cell Clc. There is a memory capacity Cst in parallel with the liquid crystal cell. Also, similar to FIG. 4, a parasitic capacity C_{SDL} exists between a node of the transistor T and the liquid crystal cell Clc, namely, the pixel electrode and the source, bus while another parasitic capacity CSDR exists between the node and the adjacent source bus.

Among these capacities, the parasitic capacity generated between a pixel electrode and the source bus has a greater influence upon the performance. This is because, specifically, a variation in a source signal affects a pixel potential through the C_{SDR} in FIG. 3 or FIG. 4 so as to greatly vary the pixel potential. Such a potential variation functions to reduce an effective voltage at the pixel or to enhance a loss of the pixel potential.

FIG. 6 illustrates an ordinary waveform developed in the pixel at the lower end of the screen in response to a cyclic variation in a square waveform of a source-bus signal at the pixel at the upper end of the screen while FIG. 7 illustrates how the signal level at the pixel is influenced by the crosstalk as in FIG. 6. The existence of the crosstalk is a primary cause of abandoning an application of the technology on the commercial basis. Even if the crosstalk is not so disadvantageous, there is a loss in the effective value of the pixel potential, and such a prediction results in a requirement of raising a level of the source signal in advance, which leads to a greater power consumption.

To cope with this, an improvement is devised which is expectantly useful to cancel the above-mentioned loss, in the light of a concept that a reversal of polarities in the source-bus potential at the laterally opposite sides of the center pixel from + to − and vice versa enables a nominal pixel potential to lie between the laterally opposite capacities Csd.

More specifically, column inversion drive or dot inversion drive can be employed to eliminate the aforementioned phenomena to some extent. The former involves applying alternate current to invert the polarity at any pair of adjacent column while the latter involves applying alternate current to invert the polarity at any pair of adjacent dots along the row direction.

Such polarity inversions in the adjacent pairs of unit columns or unit rows of the pixels still cause the crosstalk because the major part of the prior art RGB (red, green and blue) pixels are deployed in longitudinal stripes, and hence, the polarity at the opposite sides of the center pixel is not reversed when a monochromatic window is to be displayed, including a case where a square black window is centered in the white background.

The present invention is made to overcome the aforementioned disadvantages in the prior art, and accordingly, it is an object of the present invention to provide a color liquid crystal display device that is improved to eliminate any influence of crosstalk, although having pixel electrodes overlapping the source electrodes and employing polarity inversions of adjacent pair of unit columns or unit dots.

### Technical Solution

According to the present invention, a color liquid crystal display device wherein liquid crystal material is sandwiched between a TFT substrate with control circuits of thin film transistors (TFTs) and a substrate located opposed to it, a plurality of rows and columns of picture elements are arranged in matrix, each row having a gate bus and each column having a source bus, polarity inversions are carried out to any adjacent pair of unit columns of the pixels or any adjacent pair of unit pixels along the row direction, and pixel electrodes partially overlap with or are close to the source buses at their respective lateral ends, is characterized in that the electrodes are arranged so that a parasitic capacitances between pixel electrodes and the source buses are identical at their respective lateral ends, and that two or more types of color layers are allocated to picture cells connected to the same source bus with the same allocation rate.

### ADVANTAGEOUS EFFECTS

In the color liquid crystal display device according to the present invention, although the polarity inversions are performed to any adjacent pair of the pixels and any adjacent pair of the unit pixels along the row direction, the color liquid crystal display device has pixel electrodes overlapped on their laterally opposite ends by two of the source buses so as to have the identical parasitic capacity on both the sides, with two or more types of the color layers being allocated at the same allocation rate to the picture cells connected to the same source bus. Hence, as a result of the polarity inversions, driving the electrodes through any single source bus permits the parasitic capacity on the laterally opposite sides of the pixel to have its level variation averaged, thereby reducing the influence of the crosstalk as a whole.

### BRIEF DESCRIPTION OF DRAWINGS

FIG. 1 illustrates a concept of an exemplary color layout for each pixel in a color liquid crystal display device according to the present invention;

FIG. 2 illustrates a concept of another exemplary color layout for each pixel in the color liquid crystal display device according to the present invention;

FIG. 3 is a schematic circuit diagram showing a parasitic capacity in the color liquid crystal display device according to the present invention;

FIGS. 4A and 4B are sectional views showing a concept of drain and source electrodes and the parasitic capacity developed in a liquid crystal cell;

FIG. 5 is a circuit diagram showing a model of the parasitic capacitance in the liquid crystal cell;

FIG. 6 depicts ordinary waveforms in the liquid crystal display device; and

FIG. 7 depicts waveforms as a consequence of crosstalk in the liquid crystal display device.

### BEST MODE FOR CARRYING OUT THE INVENTION

Hereinafter, embodiments of the present invention will be described in detail.

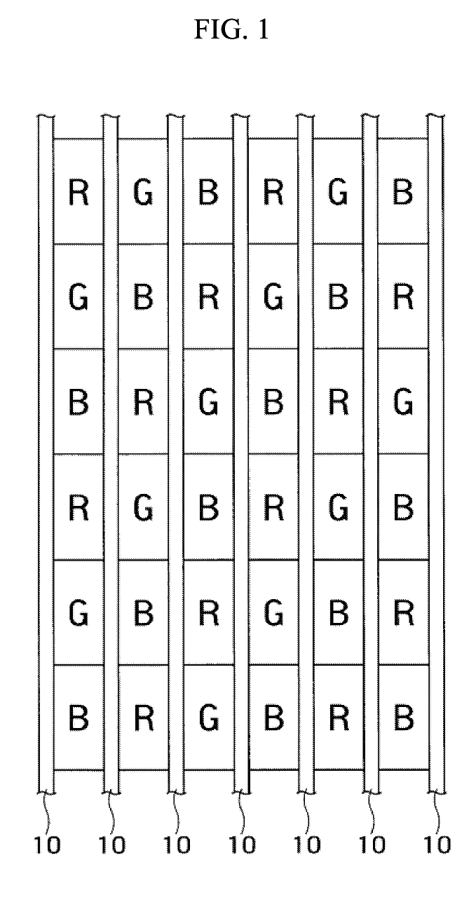

FIG. 1 is a plan view of an embodiment of a color liquid display device according to the present invention, illustrating a layout of color filters. In this embodiment, the color filters lying between a plurality of source buses 10 are arranged in a layout where three of colors RGB, namely, red, green and blue, in a certain pattern are connected in sequence so that any adjacent pair of the color filters in two adjacent columns are different in color. Thus, the rate of the colors are accurately 1/3:1/3:1/3 as a whole in the display device. If almost the same rate of the colors is applied to the color layout in any single column, there is no need of the aforementioned requirement of the different colors in any adjacent pair of the color filters, and they may be the same in color in adjacent columns.

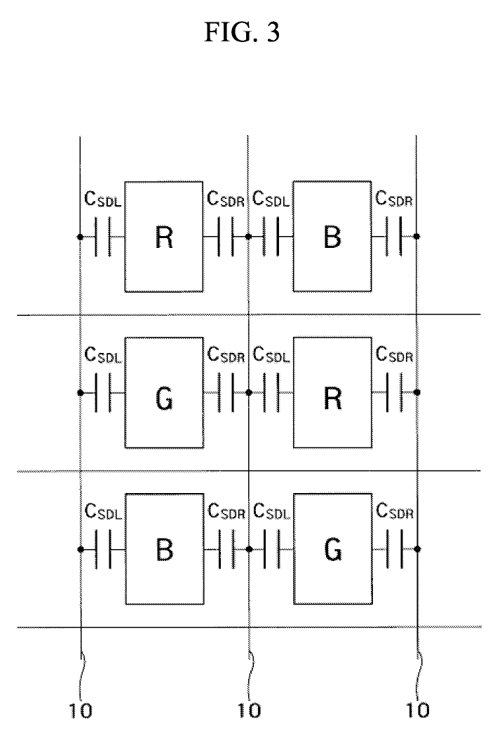

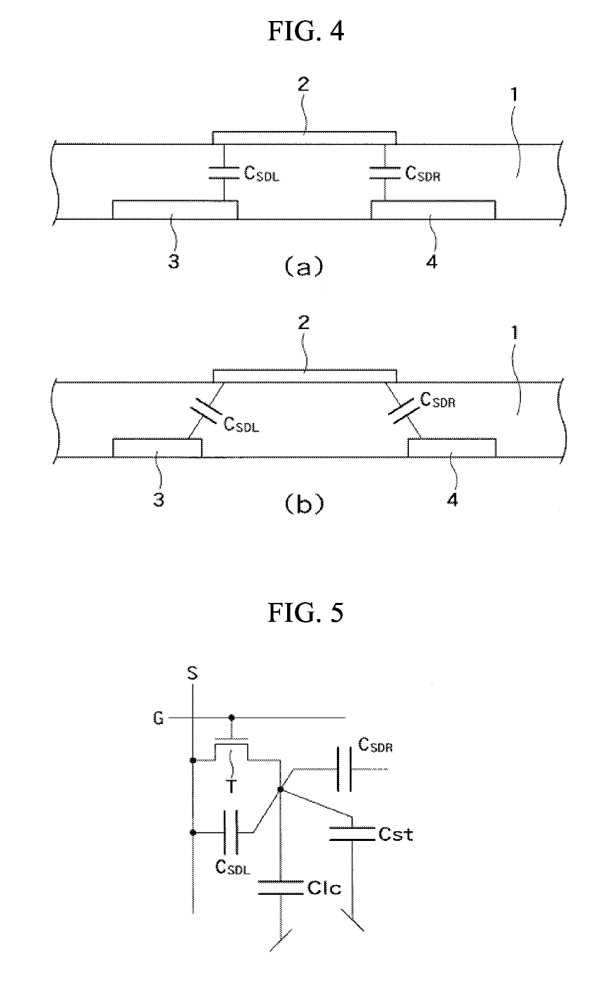

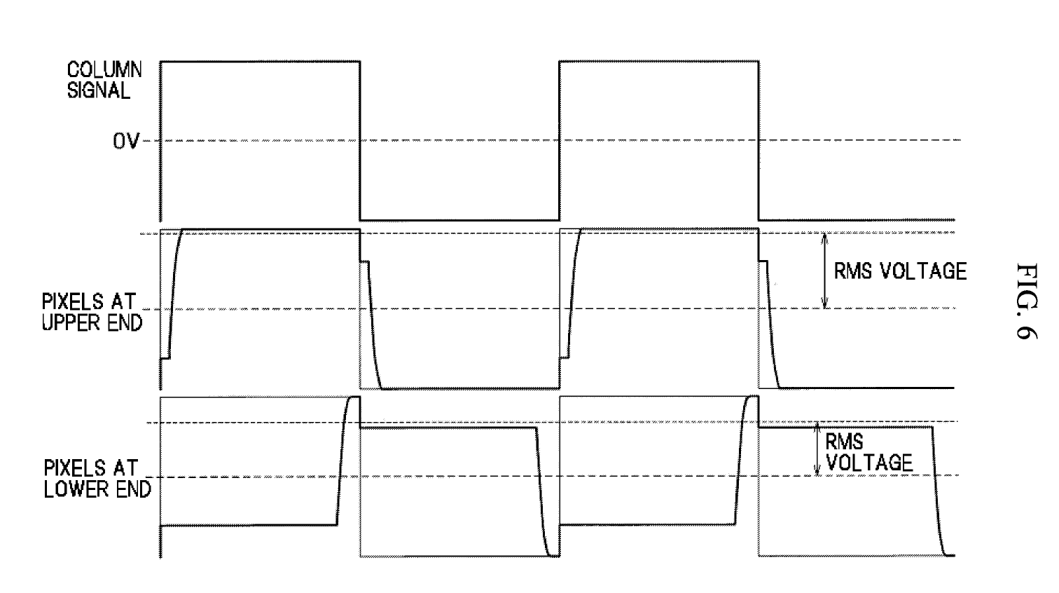

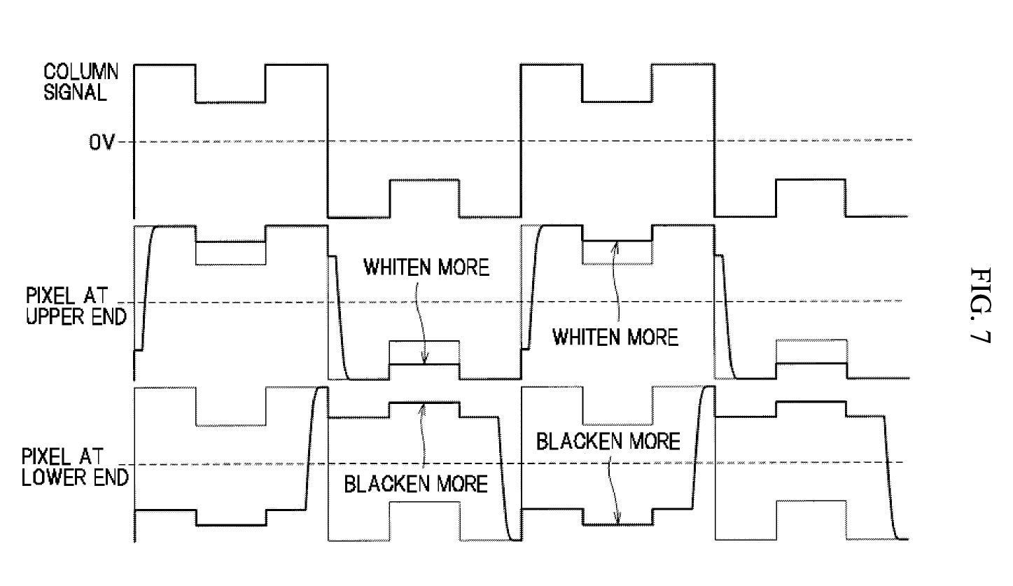

FIG. 3 is an equivalent circuit to FIG. 1, illustrating the parasitic capacitances on the laterally opposite sides of the color filters between any adjacent pair of the drain electrodes extended between the source buses are C_{SDL} on their left and C_{SDR} on their right, respectively, without exception regardless of their respective colors. In general, when insulating material sandwiched between the substrates is uniform throughout a layer, the only requirement is that an area of the drain electrodes overlapping the source electrodes is thoroughly uniform. Even if the area varies from one portion to another, substance, distance, and shapes may accordingly be varied to keep the parasitic capacitance the same anywhere in the device.

In this way, signals in the source buses connected to any adjacent pair of the pixels are compensated through polarity inversions even in a case of displaying a monochromatic window because a window and the background respectively RGB (red, green, and blue) in color are thoroughly uniform in potential, and hence, no crosstalk is apparently developed.

The color layout in FIG. 1 may be of any type if three of the colors are evenly allocated in any single column, and an alternative to this may have the colors in the second column shifted to those in the third in FIG. 1, or alternatives that are symmetrical about longitudinal and lateral center lines and about a center point may be accepted.

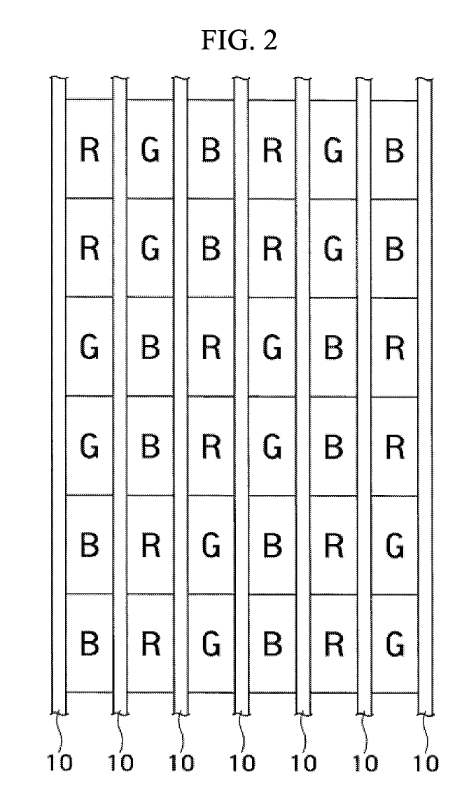

FIG. 2 depicts a color layout where, in any single column, each of three of the colors appears twice in series and then changes to another so that the column contains all of them at the same rate as a whole. In this case, also alternatively, symmetrical layout versions about longitudinal and lateral centerline and about a center point may be accepted.

Although the aforementioned layouts are all regular in color filter pattern, it is not necessarily required, and the pixels connected to the source trains are of colors at the same allocation rate.

In accordance with the present invention, the concept that the parasitic capacity should be positively used is introduced, and to make it effective, an architecture that permits a greater parasitic capacity can be used.

For instance, it is advantageous to reduce a thickness of an insulation film separating the pixels from the source buses, and this effectively enables the manufacturers to save time required for the manufacturing and restrict costs for the required processes and materials.

The thinning of the insulating film is suitable to reduce a height of steps that are left after eliminating the insulating film, and this is effective to inhibit a phenomenon of domain caused by uneven orientation of the liquid crystal.

### [DESCRIPTION OF REFERENCE NUMERALS]

1 Liquid crystal
2 Drain electrode
3, 4 Source electrode
10 Source bus

1. A color liquid crystal display device wherein liquid crystal material is sandwiched between a TFT substrate with control circuits of thin film transistors (TFTs) and a substrate located opposed to it, a plurality of rows and columns of picture elements are arranged in matrix, each row having a gate bus and each column having a source bus, polarity inversions are carried out to any adjacent pair of unit columns of the pixels or any adjacent pair of unit pixels along the row direction, and pixel electrodes partially overlap with or are close to the source buses at their respective lateral ends, characterized in that the electrodes are arranged so that a parasitic capacitances between pixel electrodes and the source buses are identical at their respective lateral ends, and that two or more types of color layers are allocated to picture cells connected to the same source bus with the same allocation rate.

2. A color liquid crystal display device as claimed in claim 1, wherein three or more colors are allocated to each picture element in any column of pixel cells connected to the same source bus.

3. A color liquid crystal display device as claimed in claim 1, wherein an insulating film in the overlapping of the pixel electrodes with the source buses is equivalent in material and uniform, and the overlapping is equivalent in amount on both the laterally opposite ends of the center pixel electrodes.

4. A color liquid crystal display device as claimed in claim 1, wherein the color layers are formed on the opposed substrate.

5. A color liquid crystal display device as claimed in claim 1, wherein the color layers are formed on the TFT substrate.
